(19) United States
(12) Patent Application Publication
(10) Pub. No.: US 2004/0192380 A1
(43) Pub. Date: Sep. 30, 2004

(54) Multi-interface wireless storage device

(75) Inventor: Wumin Chen, Taipei (TW)

Correspondence Address: BACON & THOMAS, PLLC, 625 SLATERS LANE, FOURTH FLOOR, ALEXANDRIA, VA, 22314

(73) Assignee: Institute for Information Industry, Taipei (TW)

(21) Appl. No.: 10/400,626

(22) Filed: Mar. 28, 2003

(51) Int. Cl. H04M 1/00

(52) U.S. Cl. 455/556.1; 455/558; 455/90.3

(57) ABSTRACT

A multi-interface wireless storage device for a portable imaging apparatus with an opened slot is disclosed, which has a wireless data transmission card and a wireless data storage unit. An adapter card in the wireless data transmission card can provide different memory card interface in coincidence with corresponding adapter slots and further couple pin information of the memory card interface to corresponding adapter slot. Next, a re-configurable interface control module sets the adapter cable as an interface of the corresponding pin information to receive image data transmitted by the portable imaging apparatus and further transmit the image data to a second wireless module of the wireless data storage unit via a first wireless module. Finally, an access control module writes the image data to a storage medium.

### BACKGROUND OF THE INVENTION

1. Field of the Invention

The present invention relates to a wireless storage device and, more particularly, to a multi-interface wireless storage device for a portable imaging apparatus.

2. Description of Related Art

With reference to FIG. 1, a typical digital camera 5 has an external memory card 51 inserted in a specific slot 52 of camera for enhancing memory capacity. As soon as a digital image is generated, a controller implemented in the camera 5 performs the image processing and stores the resulting image data in a storage device 51 (in this case, a memory card). When outputting the image data stored in the memory card 51, an interface (e.g., a universal serial bus (USB) or IEEE 1394 port) in the camera 5 is connected to a personal computer (PC), such that the image data is copied from the camera 5 to the PC. Alternatively, when the card 51 is inserted in a card reader 53 shown in FIG. 2 to connect the reader 53 and a computer system 54, the image data is transmitted from the card 53 to the computer system 54 for subsequent editing or recording process.

However, the current commercial memory cards generally suffer limited capacity like 128 MB or 256 MB, and high price like about or even over US$ 100. Additionally, most memory cards from different suppliers are incompatible, wherein the memory cards include compact flash, smart media, memory stick, secure digital and the like. Accordingly, typical imaging apparatus (including digital camera, digital video camera and the like) have many disadvantages aforementioned.

### SUMMARY OF THE INVENTION

An object of the present invention is to provide a multi-interface wireless storage device, which can combine typical hard disks or larger capacity storage as a storage in a portable imaging apparatus, thereby increasing storage capacity and expandability and lowering price for sale.

Another object of the present invention is to provide a multi-interface wireless storage device, which can support various memory cards to obtain multi-function and directly apply to existing portable imaging apparatus to obtain high practicality.

A further object of the present invention is to provide a multi-interface wireless storage device, which uses wireless transmission technique to transmit and receive data, and thus activity range of a portable imaging apparatus is not limited by the storage location.

To achieve the object, the multi-interface wireless storage device of the present invention consists of a wireless data transmission card and a wireless data storage unit and is applicable to a portable imaging apparatus with an opened slot.

The wireless data transmission card includes an adapter card and a wireless transmission unit. The adapter card has a memory card interface and adapter slot. The memory card interface is inserted to the opened slot of the portable imaging apparatus for extracting image data from the portable imaging apparatus. The adapter slot defines pin information with respect to the memory card interface. The wireless transmission unit has an adapter cable, a re-configurable interface control module, and a first wireless module. The adapter cable is inserted into the adapter slot such that the re-configurable interface control module can detect the pin information and accordingly set the pins as an interface with respect to the pin information. The re-configurable interface control module further extracts image data from the adapter card through the adapter cable and converts it into data signals corresponding to the first wireless module. The data signals are converted into a radio wave for transmission by the first wireless module. The wireless data storage unit includes a second wireless module, a storage medium, and an access control module. The second wireless module receives the radio wave and recovers the image data from the radio wave. The access control module extracts the image data from the second wireless module and then writes it into the storage medium.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of a typical digital camera with a memory card;

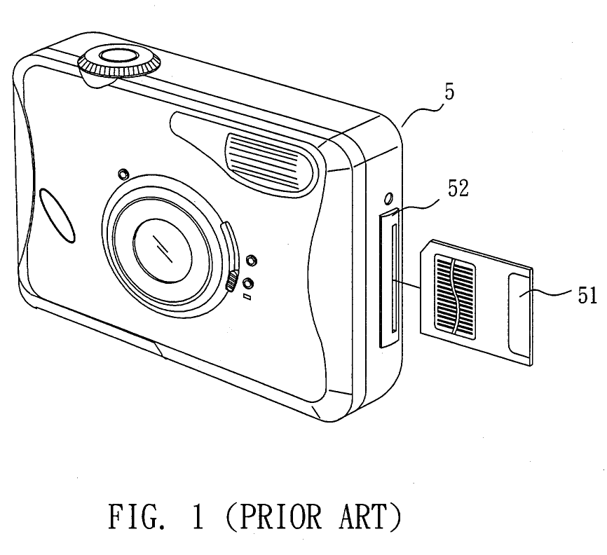

FIG. 2 is a schematic diagram of a typical card reader for digital camera;

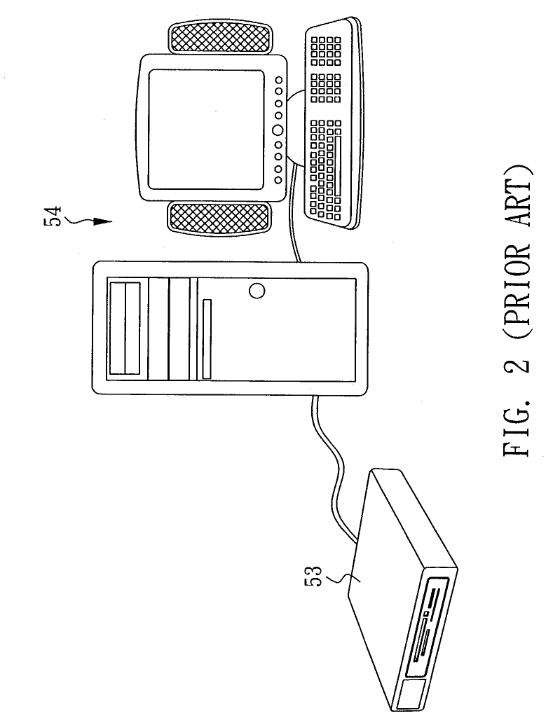

FIG. 3 is a functional block diagram of a wireless data transmission card according to an embodiment of the present invention;

FIG. 4 is a functional block diagram of a wireless data storage unit according to the embodiment of the present invention; and

FIG. 5 is a flowchart of the embodiment of the present invention.

### DETAILED DESCRIPTION OF THE PREFERRED EMBODIMENT

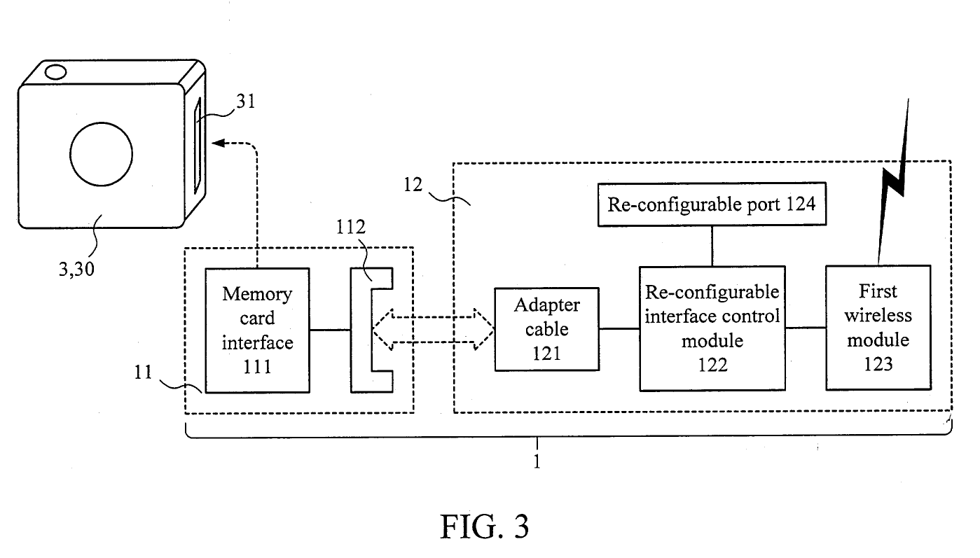

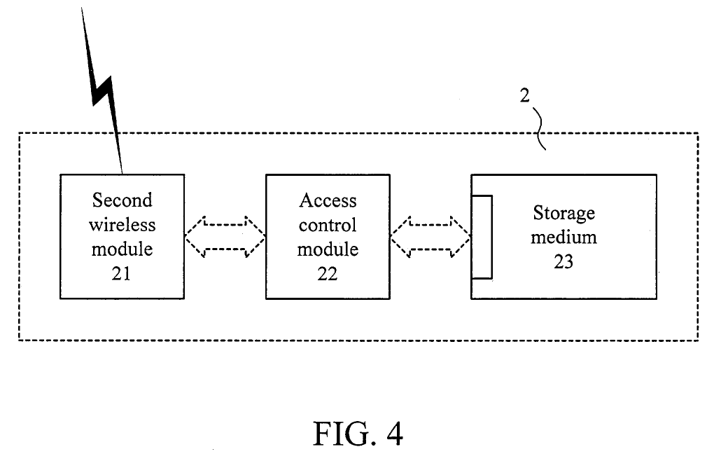

With reference to FIGS. 3, 4 and 5, there is shown a multi-interface wireless storage device. The multi-interface wireless storage device is applied to a portable imaging apparatus 3 (in this case, a digital camera 30, but a digital video camera or the like is also applicable). The multi-interface wireless storage device includes two parts: a wireless data transmission card 1 shown in FIG. 3 and a wireless data storage unit 2 shown in FIG. 4. The wireless data transmission card 1 is inserted to an opened slot 31 on a lateral of the digital camera 30 for converting data into wireless image data, instead of the data written to the prior memory card. The wireless image data is transmitted to the wireless data storage unit 2. The wireless data transmission card 1, the wireless data storage unit 2 and data transmission between the devices are described hereinafter.

The wireless data transmission card 1 consists of an adapter card 11 and a wireless transmission unit 12. The adapter card 11 has a memory card interface 111 and an adapter slot 112. The wireless transmission unit 12 has an adapter cable 121, a re-configurable interface control module 122, a first wireless module 123 and a re-configurable port 124. The format of the memory card interface 111 can be alternatively designed to different digital cameras 30 with various memory card interfaces 111 such as CF, SM, MS, SD or the like interface. The adapter card 11 is essentially used to couple cable pins or signal pins on the memory card interface 111 to the adapter slot 112 so that the adapter cable 121 is set to define corresponding interface pin information by means of the adapter slot 112 via the re-configurable port 124 when the adapter cable 121 of the wireless transmission unit 12 is inserted into the adapter slot 112 (S501).

It is noted that the step S501 is adapted to initially insert the wireless data transmission card 1 into the slot 31 of the digital camera 30. For example, the adapter cable 121 connecting to the re-configurable interface control module 122 is set to define CF card interface pins via the re-configurable port 124 when the memory card interface 111 is a CF card interface. When the CF card interface is replaced with an SM card interface, the re-configuration is completed by setting the adapter cable 121 to define SM card interface pins via the re-configurable port 124 again. After the configuration, the step S501 can be omitted in case of the same memory card interface 111 in use without changing the defined adapter cable.

In this embodiment, the adapter slot 112 is a general purpose input and output (GPIO) slot, the adapter cable 121 is a GPIO cable, and in this case, the re-configurable interface control module 122 is preferably a re-configurable chip such as a programmable integrated circuit (PIC) mono-chip, a complex programmable logic device (CPLD) chip, a field programmable gate array (FPGA) chip or the like. The re-configurable chip can serve as a control of the first wireless module 123 in addition to receiving pin information of the memory card interface 111 transmitted through the adapter cable 121. The re-configurable port 124 re-configured the adapter cable 121 definition for using boundary scan test logic defined by IEEE joint test action group (JTAG), for example.

After the adapter cable 121 is set to define pin information of the corresponding memory card interface 111, the re-configurable interface control module 122 can start the control via the memory card interface 111. Thus, the re-configurable interface control module 122 generates a control signal to set the first wireless module 123 in case of power-on digital camera 30. The first wireless module 123 then communicates with the second wireless module 21 of the wireless data storage unit 2 in order to set up a wireless data transmission channel (S502). The initialization of the multi-interface wireless storage device is therefore completed when the transmission channel is completed. The first wireless module 123 and the second wireless module 21 of this embodiment are preferably a Bluetooth module.

After the initialization, the wireless data transmission card 1 informs that the digital camera 30 is mounted and ready to work. At the time, the digital camera 30 is no consciousness of the wireless data transmission card 1 and the wireless data storage unit 2. This means that the digital camera 30 writes image data to the wireless data transmission card 1 as original matter as the image data is written to the memory card.

While the digital camera 30 writes the image data to the wireless data transmission 1, the re-configurable interface control module 122 can directly receive the image data from the digital camera 30 via the adapter cable 121 (S503). This is because the adapter cable 121 is pre-set to define pins of the corresponding memory card interface 111. Next, the module 122 converts the image data received into data signals corresponding to the first wireless module 123 (S504), and transfers the data signals to the first wireless module 123 (e.g., using RS-232 interface to transfer the data signals). Next, the first wireless module 123 converts the data signals into radio data signals and transfers it to the second wireless module 21 via the pre-set wireless data channel (S505).

When the second wireless module 21 of the wireless data storage unit 2 receives the radio data signals transferred by the first wireless module 123, the radio data signals are restored to the original image data (S506). The image data restored is then written to the storage medium 23 by the access control module 22(S507). The storage medium 23 is preferably an integrated drive electronics (IDE) hard disk for use as a compact storage. The access control module 22 can be implemented by a PIC, CPLD or FPGA chip, or is an IDE hard disk control chip which uses an IDE interface to write image data to the storage medium 23.

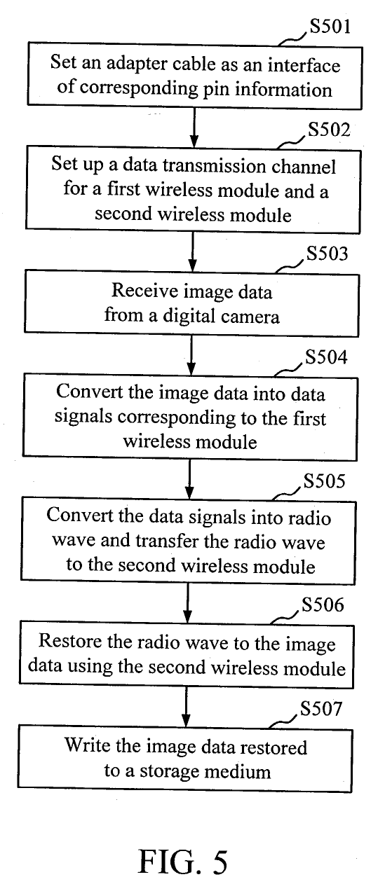

However, when the digital camera 30 performs a data write to the memory card, the inventive multi-interface wireless storage device is used to simulate the memory card function to store image data from the digital camera 30. Similarly, for a data read, the digital camera 30 sends the image data reading instruction to the multi-interface wireless storage device in order to transfer the image data in the storage medium 23 to the first wireless module 123 and the digital camera 30 via the second wireless module 21. The aforementioned data flow is reverse to a data write operation shown in FIG. 5.

As aforementioned, the inventive multi-interface wireless storage device can considerably add to ten or even hundred multiplies of original memory capacity in the portable imaging apparatus due to using storage medium such as an IDE hard disk to replace the memory card. Additionally, the cost like the IDE hard disk is much lower than FLASH memories and thus a consumer is stronger in use. The present invention can also support various memory card interfaces because of a memory card interface compatible to slot format used in a portable imaging apparatus. This makes the portable imaging apparatus use original image data access method to a built-in memory card without affecting the normal operation at the portable imaging apparatus. This is actually an advanced feature.

Although the present invention has been explained in relation to its preferred embodiment, it is to be understood that many other possible modifications and variations can be made without departing from the spirit and scope of the invention as hereinafter claimed.

What is claimed is:

1. A multi-interface wireless storage device, applied to a portable imaging apparatus with an opened slot, comprising:
a wireless data transmission card including:
an adapter having a memory card interface and an adapter slot, wherein the memory card interface is inserted into the adapter slot to fetch image data in the portable imaging apparatus and the adapter slot is defined with pin information corresponding to the memory card interface ; and
a wireless transmission unit having an adapter cable, a re-configurable interface control module and a first wireless module, wherein the adapter cable is inserted into the adapter slot, so that pin information of the adapter slot is detected by the re-configurable interface control module and accordingly to set the adapter cable as an interface of the corresponding pin information, extract the image data from the adapter card via the adapter cable, convert the image data into data signals corresponding to the first wireless module, and convert the data signals into radio wave for transmission via the first wireless module; and
a wireless data storage unit including:
a second wireless module to receive the radio wave transferred by the first wireless module and restore the radio wave received to the image data;
a storage medium; and
an access control module to fetch the image data from the second wireless module and write the image data fetched to the storage medium.

2. The device as claimed in claim 1, wherein the adapter slot is a general purpose input and output (GPIO) slot.

3. The device as claimed in claim 1, wherein the adapter cable is a GPIO cable.

4. The device as claimed in claim 1, wherein the first wireless module is a Bluetooth module.

5. The device as claimed in claim 1, wherein the re-configurable interface control module has an RS-232 interface to transfer the data signals to the wireless module.

6. The device as claimed in claim 1, wherein the re-configurable interface control module has a re-configurable port to set the adapter cable as the interface of the corresponding pin information.

7. The device as claimed in claim 6, wherein the re-configurable port has a boundary scan test logic defined by IEEE JTAG group to re-define the adapter cable.

8. The device as claimed in claim 1, wherein the re-configurable interface control module is a re-configurable chip.

9. The device as claimed in claim 8, wherein the re-configurable interface control module is a programmable integrated circuit (PIC) chip.

10. The device as claimed in claim 8, wherein the re-configurable interface control module is a complex programmable logic device (CPLD) chip.

11. The device as claimed in claim 8, wherein the re-configurable interface control module is a field programmable gate array (FPGA) chip.

12. The device as claimed in claim 1, wherein the second wireless module is a Bluetooth module.

13. The device as claimed in claim 1, wherein the access control module is a control chip for an IDE hard disk.

14. The device as claimed in claim 1, wherein the access control module is a PIC mono-chip.

15. The device as claimed in claim 1, wherein the access control module is a CPLD chip.

16. The device as claimed in claim 1, wherein the access control module is an FPGA chip.

17. The device as claimed in claim 1, wherein the storage medium is an IDE hard disk.

18. The device as claimed in claim 17, wherein the access control module has an IDE interface to write the image data to the storage medium.

19. The device as claimed in claim 1, wherein the portable imaging apparatus comprises a read image data instruction to transmit the image data stored in the storage medium to the first wireless module and to the portable imaging apparatus via the second wireless module.

20. The device as claimed in claim 1, wherein the portable imaging apparatus is a digital camera.

21. The device as claimed in claim 1, wherein the portable imaging apparatus is a digital video camera.
